(19) United States
(12) Patent Application Publication
(10) Pub. No.: US 2023/0126627 A1
(43) Pub. Date: Apr. 27, 2023

(54) PROJECTION DEVICE, INFORMATION PROCESSING DEVICE, AND DRIVE CIRCUIT

(71) Applicant: SONY SEMICONDUCTOR SOLUTIONS CORPORATION, KANAGAWA (JP)

(72) Inventor: NOBUO IWASAKI, KANAGAWA (JP)

(21) Appl. No.: 17/758,905

(22) PCT Filed: Jan. 5, 2021
(86) PCT No.: PCT/JP2021/000121

§ 371 Date: Dec. 29, 2022

(30) Foreign Application Priority Data
Jan. 24, 2020 (JP) 2020-010225

(51) Int. Cl. G03H 1/22; G03H 1/02

(52) U.S. Cl. CPC G03H 1/2294; G03H 1/02; G03H 2001/0224; G03H 2001/026

(57) ABSTRACT

Image persistence of the spatial light modulator is suppressed. A projection device (1) includes: an illumination optical system (12) that emits light; an information processing unit (20) that generates a hologram pattern based on an input image; a spatial light modulator (14) that forms the hologram pattern generated by the information processing unit and transmits light emitted by the illumination optical system; and a projection optical system (16) that projects an output of the spatial light modulator onto a projection surface and projects an output image, and the information processing unit generates the new hologram pattern obtained by shifting the hologram pattern in a predetermined direction for every predetermined frame.

### TECHNICAL FIELD

The present disclosure relates to a projection device, an information processing device, and a drive circuit.

### BACKGROUND ART

There is a technology of outputting a hologram pattern to a spatial light modulator (SLM) using an information processing device and irradiating the hologram pattern with light to display a video. In a display or the like using a liquid crystal, when a still image or a moving image with little motion is continuously projected, image quality is deteriorated due to image persistence derived from impurity ions present in the liquid crystal. In a case where a hologram pattern is output to the SLM, in a case where the pattern is sequentially switched, it is considered that localization of impurity ions is relatively small. However, in a case where still image display or the like is executed or in a case where a new pattern is generated with reference to a previous frame, a problem of localization of impurity ions may also exist in the SLM.

### CITATION LIST

### Patent Document

Patent Document 1: Japanese Patent Application Laid-Open No. 2016-161621

### SUMMARY OF THE INVENTION

### Problems to be Solved by the Invention

However, many spatial light modulators use liquid crystal for the phase modulation portion, and by maintaining the same change state for a long time in a region used to project a still image or a background portion or the like with little motion in a moving image, impurity ions are unevenly distributed, which causes image persistence. This image persistence causes degradation of the projection image in a short period of time, and also reduces accuracy of phase modulation in a long period of time because image persistence in the same situation continues.

Therefore, the present disclosure provides a projection device that suppresses image persistence of a spatial light modulator.

### Solutions to Problems

According to one embodiment, a projection device includes: an illumination optical system that emits light; an information processing unit that generates a hologram pattern based on an input image; a spatial light modulator that forms the hologram pattern generated by the information processing unit and transmits light emitted by the illumination optical system; and a projection optical system that projects an output of the spatial light modulator onto a projection surface and projects an output image, and the information processing unit generates a new hologram pattern obtained by shifting the hologram pattern in a predetermined direction for every predetermined frame.

The spatial light modulator may include a liquid crystal.

The predetermined direction may be a direction based on an alignment of the liquid crystal. Thus, the uneven distribution of impurity ions can be efficiently eliminated by performing the shift in the alignment direction of the liquid crystal.

The information processing unit may shift the hologram pattern in a predetermined direction in a pixel unit. The pixel unit may be one pixel unit, two pixel units, . . . , or a predetermined number of pixel units to the extent that the image does not collapse appropriately.

The information processing unit may shift the hologram pattern in a direction opposite to the predetermined direction after shifting by a predetermined number of pixels.

The information processing unit may shift the hologram pattern in a direction opposite to the predetermined direction by a predetermined number of pixels. For example, after the shift is repeated by a predetermined number of frames, the shift may be performed so as to go back by a predetermined number of frames in a direction opposite to the predetermined direction. Such shifting in the opposite direction may suppress image persistence while maintaining the accuracy of the output image.

In a case where the hologram pattern is shifted in a predetermined direction, the information processing unit may generate a random pattern at an end of the hologram pattern on a side opposite to the predetermined direction.

In a case where the hologram pattern is shifted in a predetermined direction, the information processing unit may calculate a phase amount on the basis of a phase amount of an adjacent pixel at an end of the hologram pattern on a side opposite to the predetermined direction and generate the pattern. As described above, the hologram pattern on the shifted opposite side may be generated.

The information processing unit may control the phase amount in each pixel of the hologram pattern on the basis of a phase difference between adjacent pixels in the hologram pattern and a shift amount.

The information processing unit may control the phase amount by controlling a voltage applied to the pixel of the hologram pattern. With this control, it is possible to control the phase difference of the wavefront diffracted in the adjacent pixel and form an image of the wavefront between the adjacent pixels at the same position on the screen in the previous frame and the current frame.

The information processing unit may control the phase amount of the hologram pattern in accordance with a lookup table (LUT). In general, in the SLM, the phase difference is represented by a difference in pixel value between adjacent pixels, and thus, this conversion of the phase amount can be easily executed by using the LUT.

In a case where the difference between the input image of the previous frame and the input image of the current frame is larger than 0 and smaller than a predetermined threshold, the information processing unit may update the shifted and acquired hologram pattern by optimization calculation. By making such a determination, the processing can be changed between frames having a large motion and frames having only a small motion.

In a case where the difference between the input image of the previous frame and the input image of the current frame is a predetermined threshold or more, the information processing unit may acquire the hologram pattern by optimization calculation using the random pattern as an initial value. Similarly to the above, by making such a determination, it is possible to change the processing between frames having large motion and between frames having only small motion.

In a case where there is motion, the information processing unit may acquire the hologram pattern by a Fourier iterative method in both a frame with large motion and a frame with small motion. That is, the Fourier iterative method can be used for both the random pattern and the shifted pattern. As described above, in a case where optimization of the hologram pattern is necessary, it can be performed by a Fourier iterative operation.

According to one embodiment, with respect to a projection device including an illumination optical system that emits light, a spatial light modulator that forms a hologram pattern and transmits light emitted by the illumination optical system, and a projection optical system that projects an output of the spatial light modulator onto a projection surface and projects an output image, an information processing device included in the projection device or an external information processing device connected to the spatial light modulator of the projection device generates a hologram pattern based on an input image and generates a new hologram pattern obtained by shifting the hologram pattern in a predetermined direction for every predetermined frame. Note that the information processing device is not limited to a case where the above-described optical system is strictly formed, and can execute a similar operation in a case where the spatial light modulator is used.

The information processing device may be provided inside the projection device.

The information processing device may be provided outside the projection device. As described above, the information processing device can execute generation and control of the hologram pattern from the inside or the outside of the projection device.

According to one embodiment, with respect to a projection device including an illumination optical system that emits light, a spatial light modulator that forms a hologram pattern and transmits the light emitted by the illumination optical system, and a projection optical system that projects an output of the spatial light modulator onto a projection surface and projects an output image, a drive circuit of the spatial light modulator included in the projection device or an external drive circuit connected to the spatial light modulator of the projection device performs control to form a new hologram pattern shifted in a predetermined direction for every predetermined frame in the spatial light modulator for the hologram pattern generated on the basis of the input image. Note that the drive circuit is not limited to the case of strictly forming the above-described optical system, and can execute a similar operation in the case of using the spatial light modulator.

The drive circuit may be provided inside the projection device.

The drive circuit may be provided outside the projection device. As described above, the drive circuit can apply the control voltage for generating the hologram pattern from the inside or the outside of the projection device.

### BRIEF DESCRIPTION OF DRAWINGS

FIG. 1 is a view schematically illustrating a projection device according to an embodiment.

FIG. 2 is a block diagram schematically illustrating an information processing device according to an embodiment.

FIG. 3 is a flowchart illustrating generation processing of a hologram pattern according to an embodiment.

FIG. 4 is a diagram illustrating an example of a shift of a hologram pattern according to an embodiment.

FIG. 5 is a diagram illustrating an example of a shift of a hologram pattern according to an embodiment.

FIG. 6 is a block diagram schematically illustrating an information processing device according to an embodiment.

FIG. 7 is a flowchart illustrating generation processing of a hologram pattern according to an embodiment.

FIG. 8 is a diagram illustrating an example of voltage value control of a hologram pattern according to an embodiment.

FIG. 9 is a flowchart illustrating generation processing of a hologram pattern according to an embodiment.

FIG. 10 is a flowchart illustrating generation processing of a hologram pattern according to an embodiment.

### MODE FOR CARRYING OUT THE INVENTION

Hereinafter, embodiments will be described with reference to the drawings. Note that, in the present specification, the expressions “larger” and “smaller” can be appropriately read as “equal to or less than” and “equal to or more than” without inconsistency, and the reverse reading is also possible.

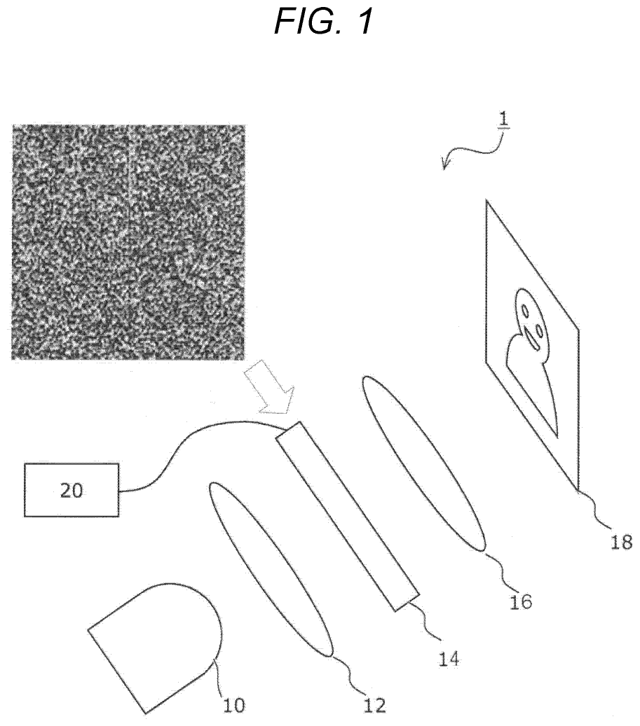

FIG. 1 is a diagram schematically illustrating a projection device according to the present disclosure. A projection device 1 includes a light source 10, an illumination optical system 12, a spatial light modulator (hereinafter, referred to as an SLM 14), a projection optical system 16, and an information processing device 20, and projects an output image on a screen 18.

The light source 10 is, for example, a device such as a laser that emits light close to coherent.

For example, the illumination optical system 12 appropriately spreads a beam system of light emitted from the light source 10 and controls the entire SLM 14 to be irradiated with coherent light. The illumination optical system 12 may be formed by, for example, a plurality of lenses.

The SLM 14 modulates the phase of light by, for example, liquid crystal. For example, since light close to coherent light is used, phases of light emitted from the illumination optical system 12 are aligned on a surface of the SLM 14 on which the light is incident. This aligned phase is modulated by the SLM 14. For example, a hologram pattern as illustrated in the upper left of the drawing is formed in the SLM 14, and a coherent plane wave passes through the hologram pattern, whereby light having a modulated phase is emitted in each pixel.

The projection optical system 16 is an optical system that projects light modulated in the SLM 14 onto a screen. The wavefront of the light modulated by the SLM 14 is diffracted by the projection optical system 16 to form an image on the screen.

The light emitted from the projection optical system 16 is projected on the screen 18, and the light emitted from each position forms an image to form an output image.

The information processing device 20 includes, for example, a drive circuit that applies a voltage to the liquid crystal, and forms a hologram pattern in the SLM 14. The information processing device 20 appropriately converts the input image and generates the hologram pattern. For example, in a case where the SLM 14 includes a liquid crystal, a phase modulation amount in each pixel is determined by applying a voltage to the liquid crystal forming each pixel of the SLM 14. The information processing device 20 acquires a phase modulation amount from the input image, and controls and outputs a voltage to be applied to the liquid crystal so as to obtain the phase modulation amount. The information processing device 20 may include a processor that executes these processes, and an electronic circuit (analog circuit, digital circuit, and mixed circuit thereof) such as a field programmable gate array (FPGA) or an application specific integrated circuit (ASIC), or information processing by software may be specifically realized using hardware resources.

The input image input to the information processing device 20 is converted into a hologram pattern, a coherent plane wave is incident on the hologram pattern to modulate the phase, and the modulated wavefront is diffracted by the projection optical system 16, whereby an output image equivalent to the input image is projected on the screen 18.

The projection device 1 may perform projection in monochromatic light, or may project a color image projected so that diffraction images of a plurality of single lights overlap on a screen. In a case of supporting a plurality of wavelengths, the information processing device 20 generates a hologram pattern on the basis of the wavelength of each light and the position of the SLM 14.

Generation of the hologram pattern from the input image in the information processing device 20 will be described in detail.

### First Embodiment

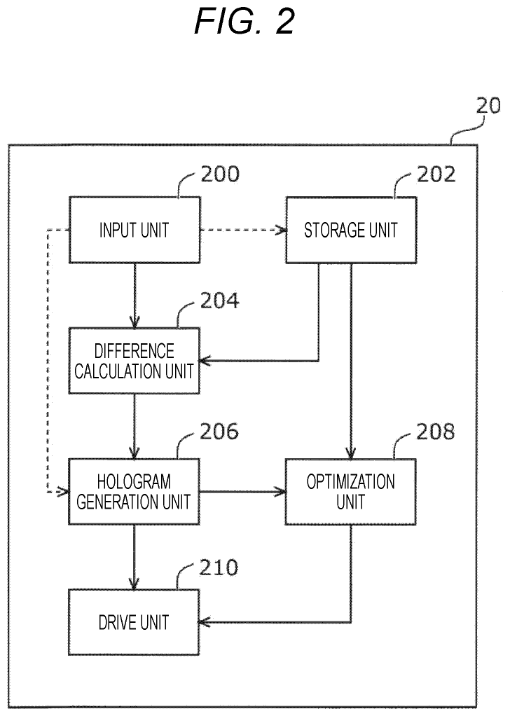

FIG. 2 is a block diagram schematically illustrating the information processing device 20 according to the present embodiment. The information processing device 20 includes an input unit 200, a storage unit 202, a difference calculation unit 204, a hologram generation unit 206, an optimization unit 208, and a drive unit 210. As described above, the information processing device 20 generates a hologram pattern from the input image and drives the SLM 14 on the basis of the hologram pattern.

The input unit 200 receives an input image. For example, in the case of a still image, information of the still image is acquired, and in the case of a moving image, an image for each frame is received. The input unit 200 may store the input image in the storage unit 202.

The storage unit 202 stores, for example, information of the input image and the hologram pattern in the current frame and the past frame. In addition, in a case where the information processing by software of the information processing device 20 is specifically realized by using hardware resources, a source code and an execution file for executing processing of the software may be stored in the storage unit 202.

The difference calculation unit 204 compares the input image (next output image) in the current frame with the input image (current output image) in the previous frame, and calculates a difference therebetween. For example, the difference calculation unit 204 may calculate differences in respective pixels between an input image of an image to be output next and a currently output input image, square the differences, and take a sum (calculate a sum of squares). In addition, the difference between these two images may be calculated by another method such as a root mean square error. For example, the difference calculation unit 204 calculates a difference from the data input from the input unit 200 and the data stored in the storage unit 202.

The hologram generation unit 206 generates a hologram pattern in which the image acquired by the input unit 200 is projected from the projection device 1. In the initial state, the hologram generation unit 206 may generate a random pattern as a hologram pattern. At the timing when the information of the previous frame exists, the hologram generation unit 206 generates the hologram pattern on the basis of the information of the previous frame and the information of the current frame. Details of the generation of the hologram pattern will be described later.

The optimization unit 208 optimizes the hologram generated by the hologram generation unit 206. For example, in a case where the hologram generation unit 206 generates a random pattern as an initial state, optimization of the hologram pattern is executed by a Fourier iterative method or the like. The optimization unit 208 may execute iterative calculation using the data of the current frame stored in the storage unit 202. Details of this optimization will also be described later.

The drive unit 210 applies a voltage so that the hologram pattern generated by the hologram generation unit 206 or a pattern based on the hologram pattern optimized by the optimization unit 208 is reflected in a liquid crystal region of the SLM 14. The generated and optimized hologram pattern is formed in the SLM 14 by the drive unit 210.

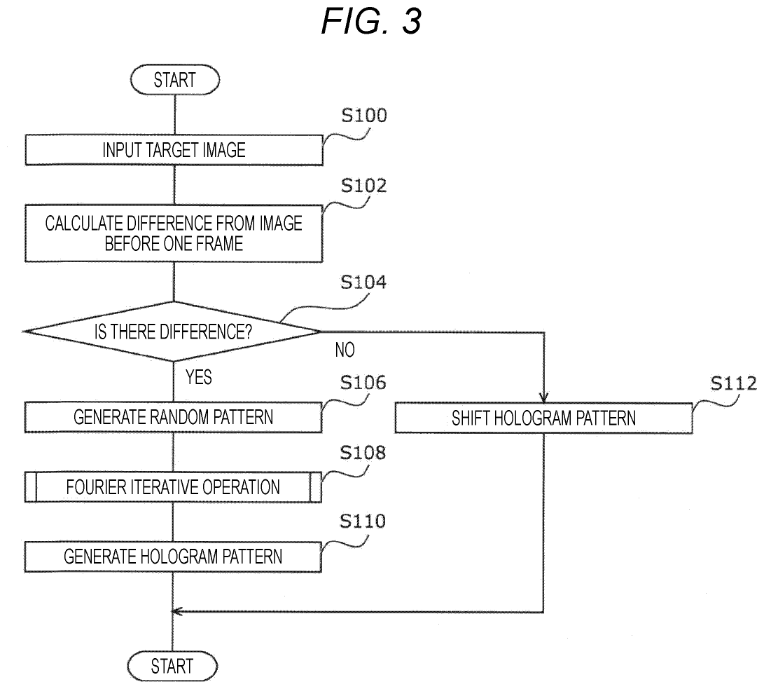

FIG. 3 is a flowchart illustrating a flow of processing according to the present embodiment.

In the initial state, the information processing device 20 generates a hologram pattern by a method similar to the normal Fourier iterative method. That is, a random pattern is generated as an initial pattern, and Fourier transform is executed using the random pattern as phase information and the wavefront information output from the illumination optical system 12 as intensity information. In the image information subjected to the Fourier transform, inverse Fourier transform is performed by replacing the intensity information with target image information (intensity information). Replaces the obtained intensity information with the actual intensity information again, and performs a Fourier transform. By repeating this operation, optimized phase information (hologram pattern) is acquired.

In a state where the hologram pattern of the previous frame exists, update of the hologram pattern is realized as in the flowchart illustrated in FIG. 3.

First, a target image is acquired via the input unit 200 (S100). This target image is referred to as a current-frame input image. This image is an image to be projected and is an image projected on the screen via the SLM 14.

Next, the difference calculation unit 204 calculates a difference from an image before a predetermined number of frames, for example, an image before one frame (S102). The difference calculation unit 204 calculates, for example, a difference between the target image before one frame (the input image of the previous frame) and the input image of the current frame. As described above, the difference is calculated by, for example, the sum of squares or the like.

Next, the hologram generation unit 206 determines whether or not there is a difference (S104). In a case where there is no difference, the hologram generation unit 206 determines that the image is in a stationary state in a still image or a moving image, and in a case where there is a difference, the hologram generation unit determines that the image is a moving image. In addition, the present invention is not limited thereto, and a signal indicating that the image is a still image or a signal indicating that the image is a moving image may be acquired together with the input of the target image, and the determination may be made by this signal.

In a case where there is a difference between the input images of the current frame and the previous frame (S104: YES), the hologram generation unit 206 generates a random pattern as an initial phase pattern (S106).

Subsequently, the optimization unit 208 executes a Fourier iterative operation using the initial phase pattern generated by the hologram generation unit 206 (S108). The hologram pattern is optimized by this iterative operation. The optimization may use an end condition in a general method, and may use, for example, a condition that the difference between the intensities in the real space is smaller than a predetermined value, a condition that a predetermined number of Fourier iterative operations are executed, or the like. Although S108 is shown as a subroutine, this should be understood as a subroutine that performs the steps of the Fourier iterative method described above.

Next, the optimization unit 208 generates a hologram pattern on the basis of the end condition (S110). For example, in a case where the difference in the intensity of the image in the real space is used as the end condition, the inverse Fourier transform is executed using the phase information at the timing when the difference becomes smaller than the predetermined value and the input image of the current frame to generate the hologram pattern representing the phase information. In a case where the condition is a condition for executing a predetermined number of Fourier iterative operations, when the finally acquired information is information in the real space, inverse Fourier transform using the phase information and the input image of the current frame is executed to generate a hologram pattern. When the finally acquired information is information in the frequency space, the phase information acquired at that timing is used as the hologram pattern.

On the other hand, in a case where there is no difference in S104 (S104: NO), the hologram generation unit 206 determines that the input image is a still image or an image having no motion from the previous frame, and shifts the hologram pattern (S112). Shifting the hologram pattern means shifting the entire image in any direction (predetermined direction) from the hologram pattern output in the previous frame in a pixel unit and acquiring the shifted image as a hologram pattern of the current frame.

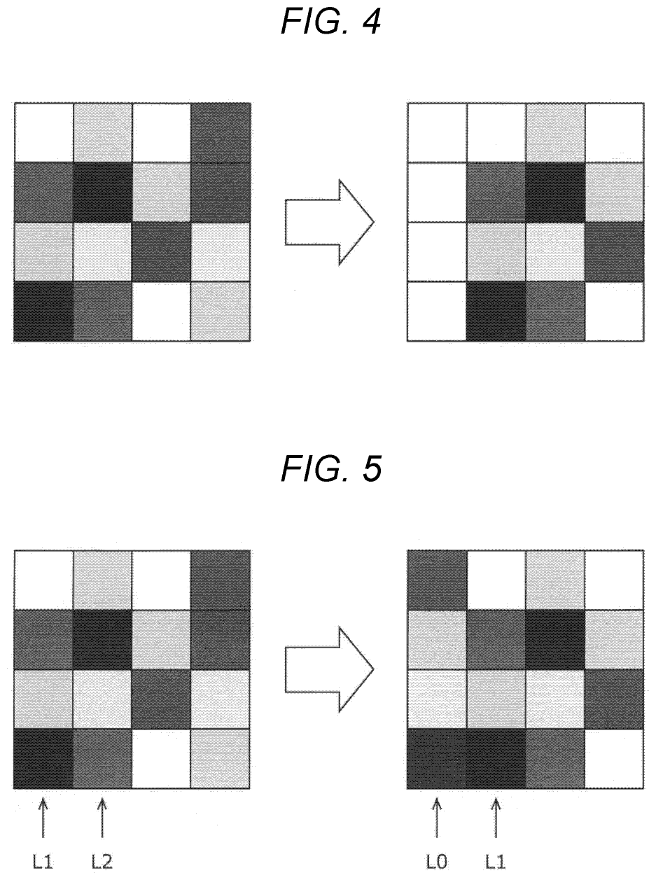

FIG. 4 is a diagram illustrating an example of a shift of a hologram pattern. Here, the hologram pattern is illustrated as 4×4 pixels, but actually, any number of pixels, for example, 256×256 pixels, 512×512 pixels, or more pixels such as HD size and 4K size may be provided.

Shifting the hologram pattern means, for example, shifting the pattern as illustrated in the left drawing by one pixel as illustrated in the right drawing. Note that the shift amount is not limited to one pixel, and, for example, the pattern may be shifted by two pixels, three pixels, or the like. The direction of the shift, that is, the predetermined direction is desirably the alignment direction of the liquid crystal molecules in the SLM 14. In the example of FIG. 4, the alignment direction of the liquid crystal molecules is preferably the left-right direction with respect to the drawing. Thus, by shifting the pattern in the alignment direction of the liquid crystal molecules, uneven distribution of impurity ions can be more efficiently suppressed. In a case of shifting the pattern by two or more pixels, a new pattern at an end opposite to the predetermined direction in the following description is generated for a plurality of pixels instead of one pixel.

FIG. 5 is a diagram illustrating another example of the shift of the hologram pattern. As shown in this figure, after the shift in the alignment direction of the liquid crystal as in FIG. 4, a random pattern may be arranged in the pixels at the end in a direction opposite to the shift direction. Furthermore, in a region at the end in the direction opposite to the shift direction, pixel values close to surrounding pixels may be used instead of a random pattern. In this case, in order to suppress the occurrence of image persistence in this region, the applied voltage value may be changed so as not to be the same pixel value.

Furthermore, the pixel value in the current frame may be determined on the basis of the phase difference between the pixel in the region in the previous frame and the adjacent pixel thereof, instead of the similar pattern. More specifically, the pixel value of the pixel belonging to L0 may be determined on the basis of the phase difference between the pixel belonging to L1 in FIG. 5 and the adjacent pixel belonging to L2 so that the phase difference between the pixel belonging to L0 in the current frame and the adjacent pixel belonging to L1 becomes equivalent. For example, when the phase difference between the pixel belonging to L1 and the pixel belonging to L2 in a certain column is φ, the pixel value of L0 may be determined so that the phase difference between the pixel belonging to L0 and the pixel belonging to L1 in the column is φ.

As described above, the shift is not limited to only one direction. For example, in every predetermined number of frames, the shift may performed in a direction opposite to the predetermined direction so as to return the amount shifted in the previous frame. For example, one pixel may be shifted in a predetermined direction in each frame, and four pixels may be shifted in a direction opposite to the predetermined direction in every five frames. After the reduction, a predetermined number of pixels may be shifted, and then the shifted predetermined number may be shifted to the opposite side so as to be restored. The random pattern and the like to be provided may be used by looping the pattern of the previous loop or may be regenerated for every loop.

By looping in this manner, it is possible to suppress image formation from a pixel located far in the pattern in the SLM 14 with respect to the position of the pixel in the image on the screen 18. Even in the case of shifting in the direction opposite to the predetermined direction, the pixel value of a random pattern and the like may be set as described above at the end opposite to the shift direction.

Furthermore, instead of shifting the hologram pattern by obtaining the difference for every frame, for example, the hologram pattern may be shifted for every predetermined number of frames such as two frames or three frames. In addition to the above description, in the description of the present aspect, the hologram pattern is shifted by one pixel for every one frame, but this may be paraphrased as shifting the hologram pattern by a predetermined number of pixels for every predetermined number of frames.

In a case where there is no difference between the previous frame and the current frame (S104: NO), the information processing device shifts the hologram pattern as described above and generates a new hologram pattern.

After the hologram pattern generation processing in FIG. 3, the drive unit 210 of the information processing device 20 controls and outputs a voltage value so as to form a new hologram pattern in the SLM 14.

As described above, according to the present embodiment, in the spatial light modulator used in the projection device, it is possible to suppress image persistence caused by continuously applying the same voltage to the liquid crystal by shifting the hologram pattern for every frame. In addition, by performing the shift in the alignment direction of the liquid crystal, uneven distribution of impurity ions in the SLM 14 can be more efficiently eliminated, and the accuracy of the image to be projected can be further improved.

### Second Embodiment

In the first embodiment described above, in the case of a still image, the hologram pattern is shifted to suppress image persistence, but in the second embodiment, after the pattern is shifted, the applied voltage is further controlled to improve the accuracy of the projection image.

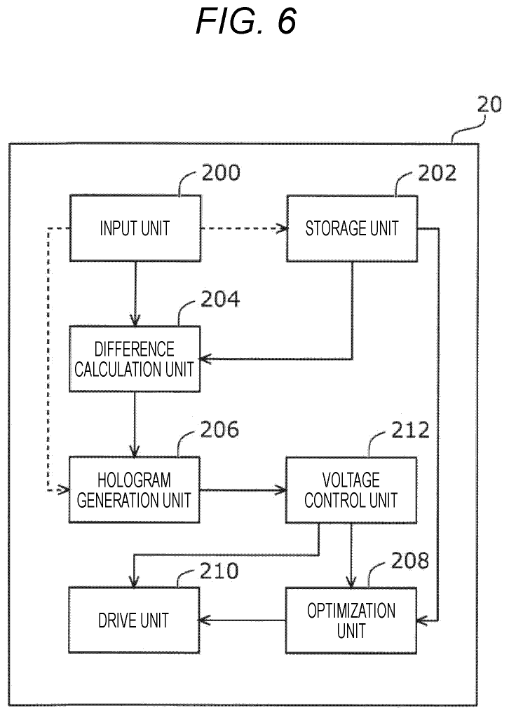

FIG. 6 is a block diagram schematically illustrating the information processing device 20 according to the present embodiment. The information processing device 20 further includes a voltage control unit 212 in addition to each configuration of the information processing device according to the first embodiment.

The voltage control unit 212 controls the voltage for the hologram pattern generated by shifting by the hologram generation unit 206 to project an accurate image.

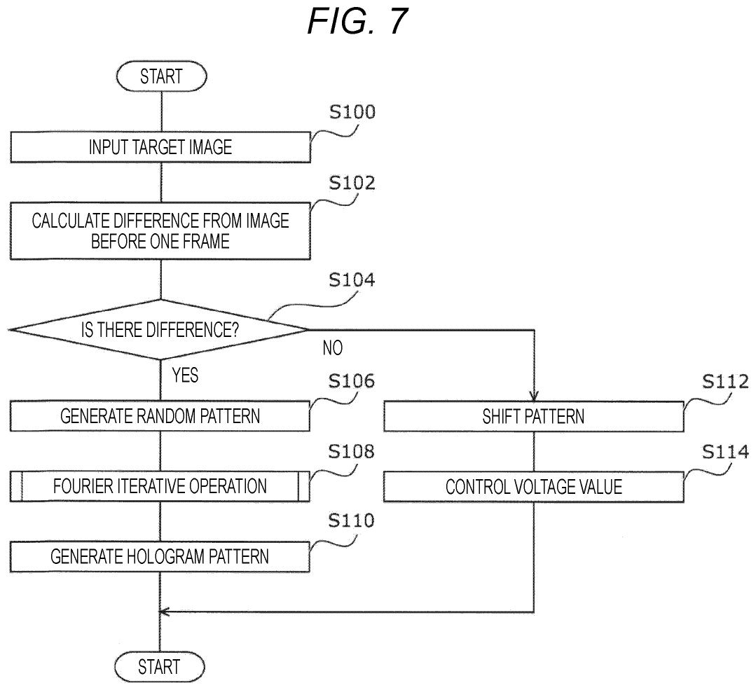

FIG. 7 is a flowchart illustrating processing of the information processing device 20 according to the present embodiment. The processing of S100 to S112 is similar to that of the first embodiment described above.

Similarly to the above-described embodiment, in a case where the hologram pattern is determined to be a still image, the information processing device 20 shifts the hologram pattern in a predetermined direction in a pixel unit (S100). Processing of the pixel at the end in the case of shifting can also be executed similarly to the first embodiment. Thereafter, the voltage control unit 212 controls a voltage value to be applied to the liquid crystal in order to form a shifted hologram pattern (S212). This control is executed using, for example, a lookup table (LUT). For example, the data of the LUT may be stored in the storage unit 202.

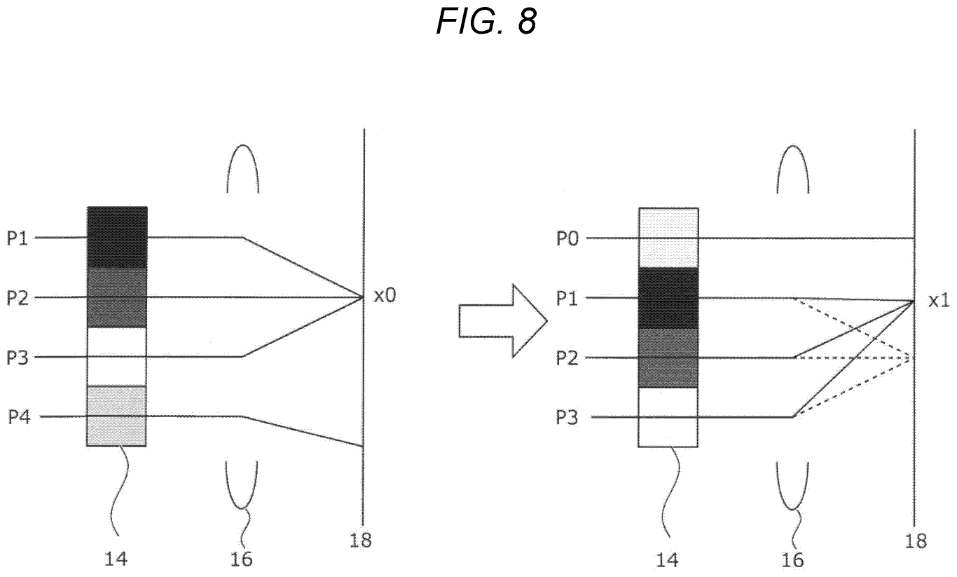

FIG. 8 illustrates an image forming position by controlling a voltage to control a phase difference between adjacent pixels. FIG. 8 is a top view of one column of pixels of the SLM 14 illustrated in FIG. 5 and the like, and is a top view of image formation in the horizontal direction illustrated in FIG. 5 and the like.

The voltage control unit 212 controls phases of adjacent pixels to control a position where an image is formed on the screen 18. The state of the previous frame is the left diagram, and the state of the current frame is the right diagram. When the hologram pattern is shifted as it is from the state illustrated in the left diagram, as illustrated on the right diagram, the image forming position is shifted by one pixel on the screen 18 as indicated by a dotted line in the current frame. Therefore, by controlling the voltage applied to the pixel value forming the shifted pattern, the image forming position in the current frame is prevented from being shifted.

For example, the voltage control unit 212 controls a voltage value to be applied to each pixel of the pattern shifted by the hologram generation unit 206 on the basis of the pattern. For example, the voltage applied to P3 of the current frame is extracted from the LUT using the pixel values P2 to P4 of the previous frame. In this LUT, for example, a correction voltage value to be applied to a pixel of interest of the current frame is stored in association with the phase difference between the pixel of interest of the previous frame and the two adjacent pixels. For example, when the unit of the phase difference is π/36 or the like and the relationship with the two adjacent pixels and the voltage value are associated with each other, an LUT of 36×36 elements is obtained, and a large cost is not generated in both the extraction of the value and the necessary storage area. Furthermore, an LUT considering the influence of two vertical pixels may be created so that the influence is reduced also in the vertical direction in FIG. 5 and the like.

If the voltage control unit 212 greatly changes the voltage to be applied by the correction voltage, there is a possibility that the image to be projected on the screen 18 is deteriorated. Therefore, the correction voltage value may be suppressed to a degree that does not affect the accuracy of the projection image. Furthermore, the value extracted from the LUT may be multiplied by a gain on the basis of the pixel value of the pixel of interest.

In the above description, the voltage control unit 212 looks at the relationship between the pixel of interest and the two adjacent pixels, but the present invention is not limited thereto. For example, a correction voltage value may be extracted from a phase difference with a pixel adjacent in a predetermined direction (shift direction). For example, the voltage control unit 212 may extract the correction voltage value to be applied to P3 of the current frame on the basis of the phase difference between P4 and P3 of the previous frame. Conversely, the correction voltage value may be extracted from the phase difference with the adjacent pixel in the direction opposite to the predetermined direction. For example, the voltage control unit 212 may extract the correction voltage value to be applied to P3 of the current frame on the basis of the phase difference between P3 and P2 of the previous frame.

As a result, by adding the correction voltage value to form the hologram pattern, it is possible to perform control so that the image forming position of the previous frame and the image forming position of the current frame are close to each other. For example, the position where the wavefront having transmitted P1 to P3 forms an image can be set to x1 indicated by a solid line from the position indicated by a broken line in the right diagram, and the image can be formed at a position closer to the image forming position x0 of the previous frame.

The voltage correction value acquired by the voltage control unit 212 is acquired for each pixel of the shifted hologram pattern generated by the hologram generation unit 206, for example. The drive unit 210 adds the correction voltage value acquired by the voltage control unit 212 to the hologram pattern generated by the hologram generation unit 206 to form a hologram pattern corrected with the correction voltage value in the SLM 14.

Note that the correction voltage value is acquired from the LUT, but the present invention is not limited thereto, and the voltage control unit 212 may calculate the correction voltage value from the phase difference with the adjacent pixel or the like by calculation. In this case, for example, an LUT indicating a relationship between a difference in pixel value from an adjacent pixel or the like and a phase difference formed between the pixel and the adjacent pixel or the like may be used.

Furthermore, the control of the correction voltage has been described above for a case where one pixel is shifted, but in a case where a plurality of pixels is shifted, the correction voltage value may be multiplied by a gain depending on the number of pixels to be shifted. For example, in the case of shifting by two pixels, the voltage control unit 212 may acquire the phase difference so as to form an image at a position shifted by two pixels.

As described above, according to the present embodiment, by controlling the shifted hologram pattern using the correction voltage value considering the phase difference in the predetermined direction of each shifted pixel, that is, by controlling the voltage for hologram pattern formation, it is possible to control the image forming position diffracted by the phase difference with the adjacent pixel in each pixel on the screen 18 to a position close to the state of the previous frame. As a result, for example, in a case where a still image is continuously projected or the like, it is possible to suppress flickering of the image projected on the screen 18 and displacement of the position of the image in accordance with the length of the projection time.

Note that, in the right diagram of FIG. 8, the image forming portion of the wavefront affected by P0 may be brought close to x1. That is, the voltage control unit 212 may estimate the phase difference between P1 and P0 in the current frame on the basis of the phase difference between P2 and P1 in the previous frame, and control the voltage value for forming the hologram pattern corresponding to P0 so that the phase difference between P1 and P0 in the current frame becomes the estimated value.

### Third Embodiment

In each of the above-described embodiments, generation of a hologram pattern for a still image has been described. In a third embodiment, it will be described that a hologram pattern is accurately and efficiently generated for a moving image. The configuration of the information processing device 20 according to the present embodiment is similar to, for example, that of the information processing device 20 illustrated in FIG. 1 according to the first embodiment.

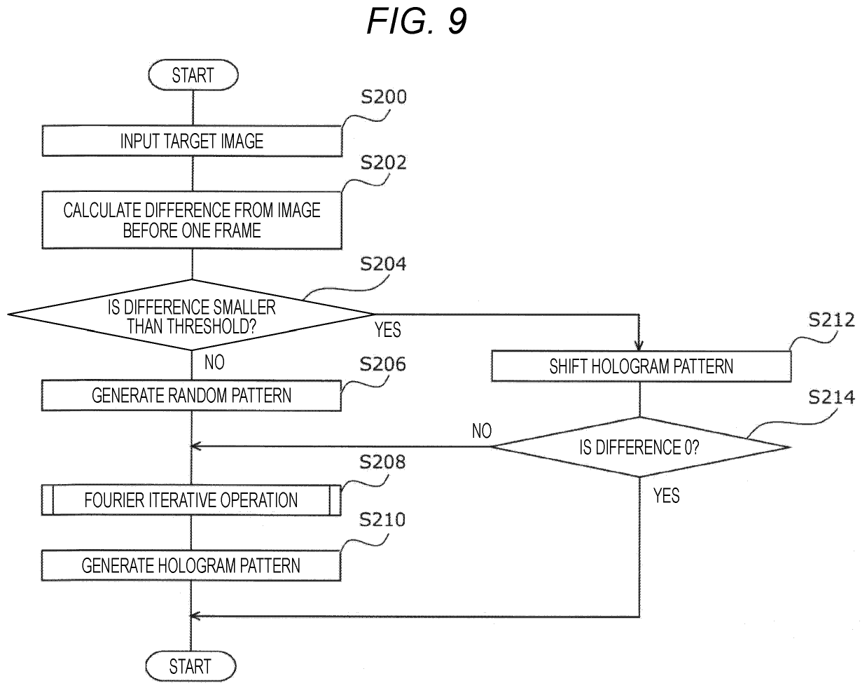

FIG. 9 is a flowchart illustrating processing of hologram pattern generation according to the present embodiment. In this flowchart, S200, S202, S206, S208, S210, and S212 are similar to S100, S102, S106, S108, S110, and S112 in FIG. 3, respectively, and thus detailed description thereof is omitted.

After obtaining the difference between the previous frame and the current frame, the hologram generation unit 206 determines whether the difference is smaller than a predetermined threshold or equal to or larger than the predetermined threshold (S204). This predetermined threshold is a threshold for determining whether or not the motion is large between frames in a case where the input image is a moving image. The hologram generation unit 206 determines whether the moving image is a moving image with large motion or a moving image with small motion by determining the magnitude relationship between the predetermined threshold and the difference.

In a case where the difference is equal to or more than the predetermined threshold (S204: NO), the hologram generation unit 206 and the optimization unit 208 execute processing similar to that of the first embodiment to generate a hologram pattern (S206 to S210).

In a case where the difference is larger than the predetermined threshold (S204: YES), the hologram generation unit 206 shifts the hologram pattern and generates a new hologram pattern (S212). As in the first embodiment, in the region on the opposite side shifted in the predetermined direction, a new pixel value is set by a random pattern or the like.

Thereafter, the hologram generation unit 206 determines whether the input image is a still image or a moving image having a slight motion (S214). In a case where it is determined that the difference calculated by the difference calculation unit 204 is 0, that is, the input image is a still image (S214: YES), the generation of the hologram pattern is ended, and the drive unit 210 controls the voltage so that the SLM 14 forms the hologram pattern as in the first embodiment.

On the other hand, in a case where the difference calculated by the difference calculation unit 204 is not 0, the hologram generation unit 206 determines that the input image is a moving image having slight motion (S214: NO). In this way, when it is determined that the moving image has a slight motion, the optimization unit 208 executes the Fourier iterative operation using the new hologram pattern shifted in the predetermined direction by the hologram generation unit 206 as phase information in the frequency space (S208). Then, after the optimization is completed and the hologram pattern is created, the hologram pattern is formed in the SLM 14 by the drive unit 210.

Note that the determination of the still image may not be performed at this timing. For example, the information processing device 20 may determine a still image, a moving image having a slight motion, and a moving image having a large motion on the basis of the difference calculated by the difference calculation unit 204 at the stage of acquiring the input image. Furthermore, in this case, in S204, determination may be made on these three types of images, and branch processing may be executed.

As described above, according to the present embodiment, in a case where the input image is a still image or a moving image having a large motion, processing similar to that of the first embodiment is performed, and in a case where the input image is a moving image having a slight motion, optimization of the hologram pattern formed in the SLM 14 is executed using the shifted hologram pattern. Between frames with a slight motion, information of a previous frame is often available in many regions thereof. Therefore, as in the present embodiment, by executing the Fourier iterative operation with the shifted hologram pattern as an initial value, it is possible to reduce the cost of optimization. As a result, according to the information processing device 20 according to the present embodiment, it is possible to efficiently execute optimization of a hologram pattern in a moving image.

### Fourth Embodiment

Of course, it is also possible to apply a moving image with a small motion as in the third embodiment to an aspect of controlling the voltage value of the second embodiment. The configuration of the information processing device 20 according to the present embodiment is similar to, for example, that of the information processing device 20 illustrated in FIG. 6 according to the second embodiment.

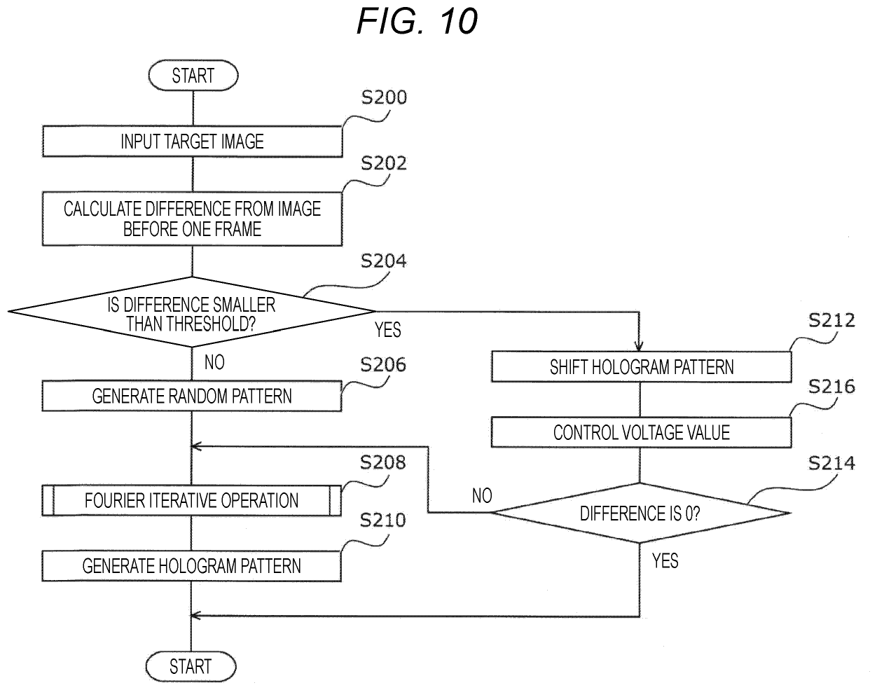

FIG. 10 is a flowchart illustrating processing of hologram pattern generation according to the fourth embodiment. In this flowchart, S200, S202, S204, S206, S208, S210, S212, and S214 are respectively similar to the processing in FIG. 9, and thus detailed description thereof is omitted.

In S212, after the hologram generation unit 206 generates the shifted hologram, the voltage control unit 212 further acquires a correction voltage value for correcting the hologram pattern using the LUT or the like, and corrects the shifted hologram pattern (S216).

The subsequent processing is similar to that of the third embodiment, and it is determined whether the image is a still image or a moving image (S214). In a case where the image is a moving image, the optimization unit 208 further executes optimization (S208). The generated hologram pattern is converted into a voltage value by the drive unit 210 and output to the SLM 14.

As described above, according to the present embodiment, in a still image or a moving image having a slight motion, after the hologram pattern of the previous frame is shifted in a predetermined direction, a correction voltage value is acquired, and it is possible to form a hologram pattern corrected in the SLM 14 by using the generated hologram pattern and the correction voltage value. As a result, it is possible to obtain a more accurate image and to realize projection of an input image including a moving image with reduced computational and temporal costs.

In all the embodiments described above, the liquid crystal is used for the SLM 14, for example, as described above. The alignment direction of the liquid crystal can be obtained, for example, by analyzing the liquid crystal. In addition, the hologram pattern in the liquid crystal can be acquired by actually inputting an input image. As a result, the third party can determine in what alignment direction in the liquid crystal, and whether or not the hologram pattern is shifted in the alignment direction, and can determine whether or not the technology of the present disclosure is used.

The method for generating a hologram pattern according to all the embodiments described above, and the device, the circuit, and the like that execute the method for generating a hologram pattern are not limited to application to a projection device. For example, it may be used for visible light communication or optical interconnection, or may be used for other devices.

The embodiment described above may have the following forms.

(1)

A projection device including:

an illumination optical system that emits light;

an information processing unit that generates a hologram pattern based on an input image;

a spatial light modulator that forms the hologram pattern generated by the information processing unit and transmits light emitted by the illumination optical system; and

a projection optical system that projects an output of the spatial light modulator onto a projection surface and projects an output image, in which

the information processing unit generates the new hologram pattern obtained by shifting the hologram pattern in a predetermined direction for every predetermined frame.

(2)

The projection device according to (1), in which

the spatial light modulator includes a liquid crystal.

(3)

The projection device according to (2), in which

the predetermined direction is a direction based on an alignment of the liquid crystal.

(4)

The projection device according to (2) or (3), in which

the information processing unit shifts the hologram pattern in the predetermined direction in a pixel unit.

(5)

The projection device according to (4), in which

the information processing unit shifts the hologram pattern in a direction opposite to the predetermined direction after shifting a predetermined number of pixels.

(6)

The projection device according to (5), in which

the information processing unit shifts the hologram pattern in a direction opposite to the predetermined direction by the predetermined number of pixels.

(7)

The projection device according to any one of (4) to (6), in which

in a case where the hologram pattern is shifted in the predetermined direction, the information processing unit generates a random pattern at an end of the hologram pattern on a side opposite to the predetermined direction.

(8)

The projection device according to any one of (4) to (7), in which

in a case where the hologram pattern is shifted in the predetermined direction, the information processing unit calculates a phase amount on the basis of a phase amount of an adjacent pixel at an end of the hologram pattern on a side opposite to the predetermined direction, and generates a pattern.

(9)

The projection device according to any one of (4) to (8), in which

the information processing unit controls a phase amount in each pixel of the hologram pattern on the basis of a phase difference between adjacent pixels in the hologram pattern and a shift amount.

(10)

The projection device according to (9), in which

the information processing unit controls the phase amount by controlling a voltage applied to a pixel of the hologram pattern.

(11)

The projection device according to any one of (9) or (10), in which

the information processing unit controls the phase amount of the hologram pattern in accordance with a lookup table (LUT).

(12)

The projection device according to any one of (1) to (11), in which

the information processing unit updates the shifted and acquired hologram pattern by optimization calculation in a case where a difference between the input image of a previous frame and the input image of a current frame is larger than 0 and smaller than a predetermined threshold.

(13)

The projection device according to (12), in which

the information processing unit updates the hologram pattern by a Fourier iterative method.

(14)

The projection device according to any one of (1) to (13), in which

the information processing unit acquires the hologram pattern by optimization calculation using a random pattern as an initial value in a case where a difference between the input image of a previous frame and the input image of a current frame is a predetermined threshold or more.

(15)

The projection device according to claim (14), in which

the information processing unit acquires the hologram pattern by a Fourier iterative method.

(16)

An information processing device that

generates a hologram pattern based on an input image, and generates the new hologram pattern obtained by shifting the hologram pattern in a predetermined direction for each predetermined frame with respect to a projection device including:

an illumination optical system that emits light;

a spatial light modulator that forms a hologram pattern and transmits light emitted by the illumination optical system; and

a projection optical system that projects an output of the spatial light modulator onto a projection surface and projects an output image.

(17)

The information processing device according to (16)

provided inside the projection device.

(18)

The information processing device according to (16)

provided outside the projection device.

(19)

A drive circuit that

performs control to form the new hologram pattern shifted in a predetermined direction for every predetermined frame in a spatial light modulator for the hologram pattern generated on the basis of an input image with respect to a projection device including:

an illumination optical system that emits light;

the spatial light modulator that forms a hologram pattern and transmits light emitted by the illumination optical system; and

a projection optical system that projects an output of the spatial light modulator onto a projection surface and projects an output image.

(20)

The drive circuit according to (19)

provided inside the projection device.

(21)

The drive circuit according to (19)

provided outside the projection device.

Aspects of the present disclosure are not limited to the above-described embodiments, but include various conceivable modifications, and the effects of the present disclosure are not limited to the above-described contents. The components in each embodiment may be appropriately combined and applied. That is, various additions, modifications, and partial deletions can be made without departing from the conceptual idea and gist of the present disclosure derived from the contents defined in the claims and equivalents thereof.

### REFERENCE SIGNS LIST

1 Projection device
10 Light source
12 Illumination optical system
14 SLM
16 Projection optical system
18 Screen
20 Information processing device
200 Input unit
202 Storage unit
204 Difference calculation unit
206 Hologram generation unit
208 Optimization unit
210 Drive unit
212 Voltage control unit

1. A projection device comprising:
an illumination optical system that emits light;
an information processing unit that generates a hologram pattern based on an input image;
a spatial light modulator that forms the hologram pattern generated by the information processing unit and transmits light emitted by the illumination optical system; and
a projection optical system that projects an output of the spatial light modulator onto a projection surface and projects an output image, wherein
the information processing unit generates the new hologram pattern obtained by shifting the hologram pattern in a predetermined direction for every predetermined frame.

2. The projection device according to claim 1, wherein
the spatial light modulator includes a liquid crystal.

3. The projection device according to claim 2, wherein
the predetermined direction is a direction based on an alignment of the liquid crystal.

4. The projection device according to claim 2, wherein
the information processing unit shifts the hologram pattern in the predetermined direction in a pixel unit.

5. The projection device according to claim 4, wherein
the information processing unit shifts the hologram pattern in a direction opposite to the predetermined direction after shifting a predetermined number of pixels.

6. The projection device according to claim 5, wherein
the information processing unit shifts the hologram pattern in a direction opposite to the predetermined direction by the predetermined number of pixels.

7. The projection device according to claim 4, wherein
in a case where the hologram pattern is shifted in the predetermined direction, the information processing unit generates a random pattern at an end of the hologram pattern on a side opposite to the predetermined direction.

8. The projection device according to claim 4, wherein
in a case where the hologram pattern is shifted in the predetermined direction, the information processing unit calculates a phase amount on a basis of a phase amount of an adjacent pixel at an end of the hologram pattern on a side opposite to the predetermined direction, and generates a pattern.

9. The projection device according to claim 4, wherein
the information processing unit controls a phase amount in each pixel of the hologram pattern on a basis of a phase difference between adjacent pixels in the hologram pattern and a shift amount.

10. The projection device according to claim 9, wherein
the information processing unit controls the phase amount by controlling a voltage applied to a pixel of the hologram pattern.

11. The projection device according to claim 9, wherein
the information processing unit controls the phase amount of the hologram pattern in accordance with a lookup table (LUT).

12. The projection device according to claim 1, wherein
the information processing unit updates the shifted and acquired hologram pattern by optimization calculation in a case where a difference between the input image of a previous frame and the input image of a current frame is larger than 0 and smaller than a predetermined threshold.

13. The projection device according to claim 12, wherein
the information processing unit updates the hologram pattern by a Fourier iterative method.

14. The projection device according to claim 1, wherein
the information processing unit acquires the hologram pattern by optimization calculation using a random pattern as an initial value in a case where a difference between the input image of a previous frame and the input image of a current frame is a predetermined threshold or more.

15. The projection device according to claim 14, wherein
the information processing unit acquires the hologram pattern by a Fourier iterative method.

16. An information processing device that
generates a hologram pattern based on an input image, and generates the new hologram pattern obtained by shifting the hologram pattern in a predetermined direction for every predetermined frame with respect to a projection device including:
an illumination optical system that emits light;
a spatial light modulator that forms a hologram pattern and transmits light emitted by the illumination optical system; and
a projection optical system that projects an output of the spatial light modulator onto a projection surface and projects an output image.

17. A drive circuit that
performs control to form the new hologram pattern shifted in a predetermined direction for every predetermined frame in a spatial light modulator for the hologram pattern generated on a basis of an input image with respect to a projection device including:
an illumination optical system that emits light;
the spatial light modulator that forms a hologram pattern and transmits light emitted by the illumination optical system; and
a projection optical system that projects an output of the spatial light modulator onto a projection surface and projects an output image.
